(19) United States
(12) Patent Application Publication
(10) Pub. No.: US 2004/0198415 A1
(43) Pub. Date: Oct. 7, 2004

(54) Mobile phone of reducing radiation injury

(76) Inventors: Cheng-Hsiung Lin, Hsinchu (TW); Susan Lin, Hsinchu (TW)

Correspondence Address: SEYFARTH SHAW, 55 EAST MONROE STREET, SUITE 4200, CHICAGO, IL, 60603-5803, US

(21) Appl. No.: 10/394,943

(22) Filed: Mar. 21, 2003

(30) Foreign Application Priority Data
Jun. 14, 2002 (TW) 091208994

(51) Int. Cl. H04B 1/38

(52) U.S. Cl. 455/550.1; 455/90.1; 455/575.1

(57) ABSTRACT

The present invention uses a shielding metal on a motherboard of a mobile phone as a natural anti-radiation shield to design a monopole antenna hidden in the housing of the mobile phone to prevent the mobile phone from breakage, and to reduce radiation in the user direction from the monopole antenna. Moreover, the monopole antenna may be further connected to a helical coil antenna wherein the helical coil antenna is located in a direction perpendicular to the monopole antenna for enhancing the radiation effect and reducing the human injury by the radiation.

### BACKGROUND OF THE INVENTION

1. Field of the Invention

The present invention relates to a mobile phone, and more particularly, to a mobile phone with an unbreakable antenna and an ability to reduce radiation injury.

2. Background of the Invention

People are gradually paying more and more attention on the radiation injury caused by the mobile phone. Since the effect of the radiation injury requires a long-term observation, there is no sufficient statistical data to prove the effect to the human body up to now. Moreover, the convenience of the mobile phone has changed people's communication behavior so that users will usually tend to ignore its potential danger. Thus, mobile phone manufacturers have not taken serious attentions to develop a safe anti-radiation antenna. To date, mobile phones possessing an anti-radiation antenna are quite rare in the market. There is only one type of absorption-mask for the electromagnetic wave that can mask a half of the antenna to achieve a unidirectional radiation effect. However, since this type of absorption-mask is inconvenient to use, it is not widely accepted in the market.

FIG. 1(a) is a diagram of a conventional mobile phone 10 and FIG. 1(b) is a cross-sectional view of the mobile phone 10. The mobile phone 10 includes an antenna 12 and a housing 14. The housing 14 of the mobile phone 10 includes a motherboard 16 and a shielding metal 18 inside, and the shielding metal 18 is used to prevent the motherboard 16 from electromagnetic interference. Since the antenna 12 is protruded beyond the housing 14, it not only increases the probability of breakage, but also results in the inconvenience for carrying. Most mobile phones in the market employ a helical coil antenna, and the radiation pattern of the helical coil antenna is omni-directional, i.e. the radiation radiates toward all directions. The mobile phone has to be used close to the ear that is equivalent to have the antenna near the human brain, a strong radiation is constantly emitted toward the human brain, and the accumulation of radiation will cause injury to the brain organization after a long-term use. FIG. 1(c) is a schematic diagram for the radiation of the mobile phone 10. For clarity of the diagram, the direction of the radiation 22 is only illustrated with two sides, and the radiation 22 is actually omni-directional, i.e. 360 degrees and emitted toward all directions. The ear 20, represented as a user, is exposed to the radiation 22 emitted by the antenna 12 obviously.

In summary, there is a need in the market to provide an antenna being unbreakable, convenient carrying, and reducing the radiation electromagnetic wave toward the user direction to replace the conventional protruding antenna.

### SUMMERY OF THE INVENTION

The primary object of the present invention is to provide an anti-radiation mobile phone that can reduce the injury to the human body caused by the radiation from the antenna of the mobile phone and increase the convenience for carrying the mobile phone. Since the electromagnetic wave cannot penetrate through a metal, a large shielding metal is used to cover electronic components on the motherboard of the mobile phone to prevent the electronic components from the interference of the external electromagnetic wave. The shielding metal is located between the human brain and the antenna during a phone call. Thus, if the current shielding metal can be used to design a type of antenna mounted inside the housing of the mobile phone, radiation of the antenna may be reduced in the direction toward the human brain and the convenience for carrying can be improved.

The present invention employs such a feature to design a monopole antenna in the housing of the mobile phone. The monopole antenna is located at the other side of the shielding metal. Consequently, the radiation at the side next to the human brain is reduced by an isolation of the metal circuit on the motherboard and the shielding metal of the mobile phone, and the strength of the radiation received by the brain is also reduced. Since the structure of the monopole antenna is simple, it needs only to adjust the geometrical dimension to obtain the desired impedance and to reduce the reflection to get a better matching.

The above-mentioned monopole antenna can be replaced by a helical coil antenna. The matching problem between the helical coil antenna and the motherboard can be resolved and suitable impedance can be obtained by changing the winding type of the coil and the dielectric coefficient of the housing.

Furthermore, the present invention can combine the monopole antenna with a conventional helical coil antenna to change the direction of radiation from the helical coil antenna by locating the helical coil antenna in a direction perpendicular to the monopole antenna. Consequently, this design not only increases the radiation effect, but also changes the direction of electromagnetic wave of the helical coil antenna to reduce the injury to the human body by the radiation.

### BRIEF DESCRIPTION OF THE DRAWINGS

Other objects and advantages of the present invention will become apparent upon reading the following description and upon reference to the accompanying drawings in which:

FIG. 1(a) and FIG. 1(b) are schematic diagrams of a mobile phone according to the prior art;

FIG. 1(c) is a schematic diagram of the radiation of a mobile phone according to the prior art;

FIG. 2 is a schematic diagram of a monopole antenna according to the prior art; and

FIG. 3(a) to FIG. 3(d) are diagrams showing the location and radiation of the antenna of a mobile phone according to the present invention.

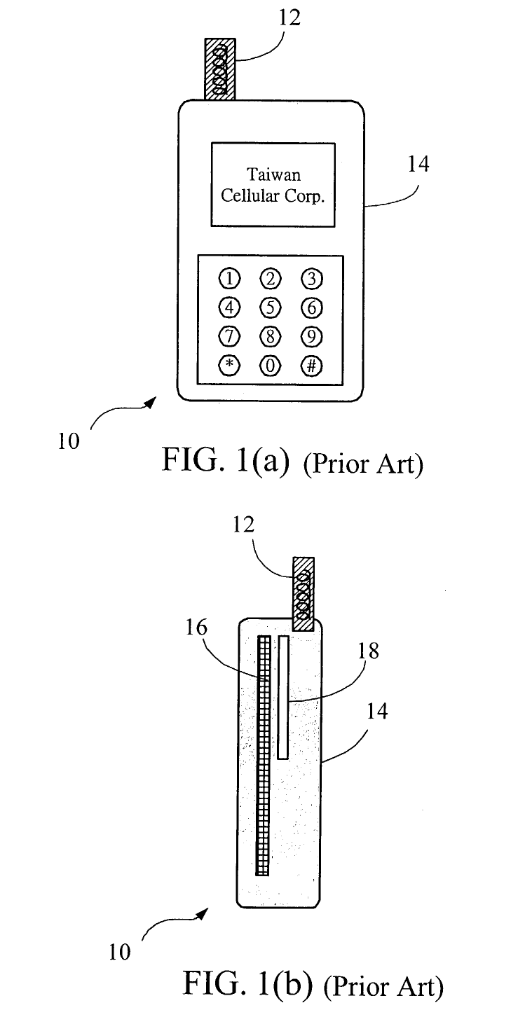

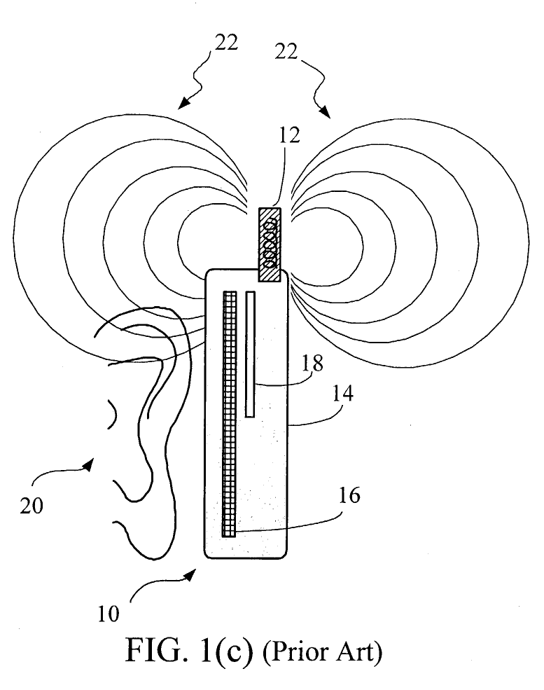

### DESCRIPTION OF PREFERRED EMBODIMENTS

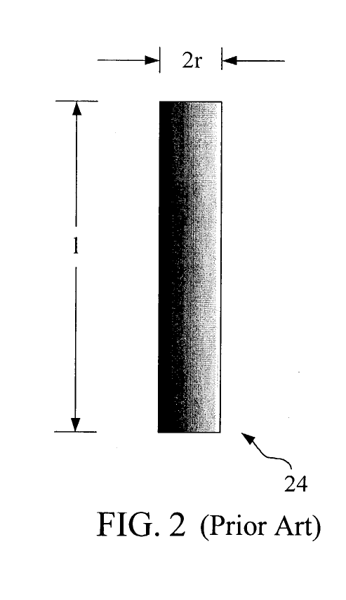

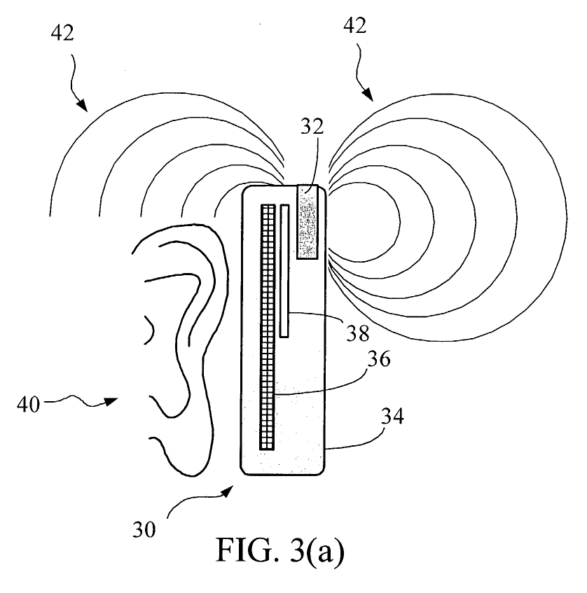

The design technique for the antenna is based on the impedance matching between the antenna and the motherboard. Referring to FIG. 2, a cylindrical monopole antenna 24 has the length of l unit and the radius of r unit, and the capacitance is Cₒ=l/(2 ln(l/r))×10⁻¹¹/9 Farad and the inductance is Lₒ=2 l(ln(2 l/r)−¾×10⁻⁹)=60 ln(l/r) Henry. The calculation is based on the assumption that the monopole antenna 24 is floating, i.e. without one end grounding and is not influenced by the frequency. Considering the actual case, the impedance Z of the monopole antenna 24 is about \sqrt{(Lₒ/Cₒ)}=60 ln(l/r) Ohms. According to the above-mentioned principles, the present invention provides a monopole antenna hidden in the housing to replace the conventional helical coil antenna and to obtain the desired impedance.

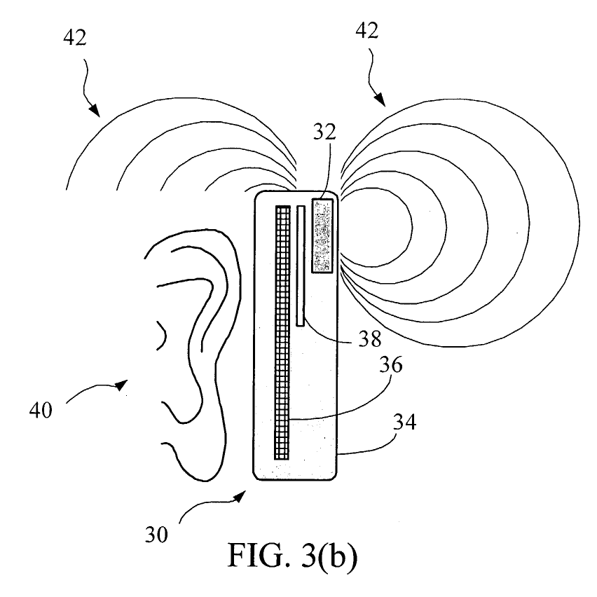

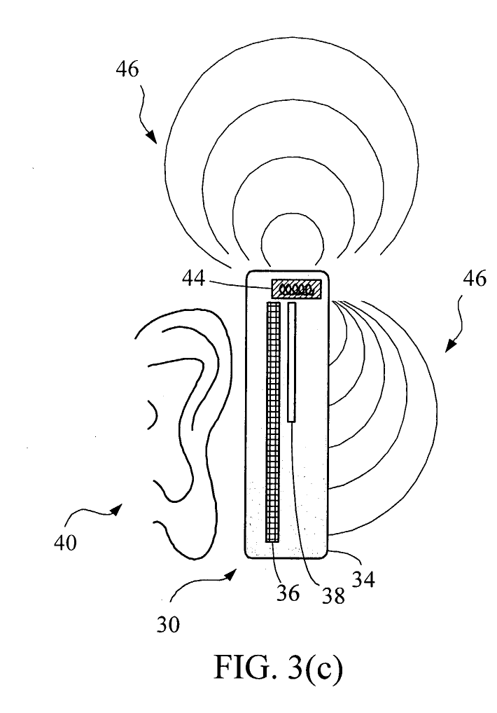

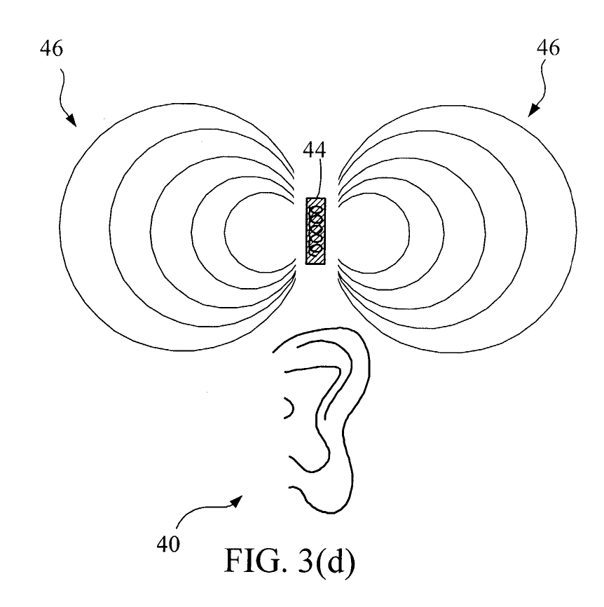

FIG. 3(a) is a schematic diagram of a mobile phone according to the present invention. A mobile phone 30 comprises a motherboard 36, a shielding metal 38 for preventing the motherboard 36 from electromagnetic interference, a housing 34 for encapsulating the motherboard 36 and the shielding metal 38, and a monopole antenna 32 positioned on an opposite side of the shielding metal 38 to the motherboard 36 and hidden inside the housing 34 or protruded slightly beyond the surface of the housing 34. Most of the monopole antenna 32 is enclosed in the housing 34, and the shielding metal 38 serves as a radiation shield to reduce the radiation 42 from the monopole antenna 32 and received by the ear 40. The present invention can be applied to the current mobile phones by simply dismantling the original antenna and replacing if with the monopole antenna 32. Regarding the matching problem between the monopole antenna 32 and the motherboard 36, an equivalent or approximate impedance to the original antenna can achieved by adjusting the length and the radius of the monopole antenna 32 according to the above-mentioned formula. Therefore, the present invention not only employs an antenna with a suitable dimension to meet the requirement of the original housing, but also hides most of the monopole antenna 32 in the housing 34 for easy carrying and reducing the damage of the monopole 32 resulting from impact. Furthermore, the monopole antenna 32 can be entirely hidden in the housing 34, as shown in FIG. 3(b), to be used by a manufacture of the mobile phone during designing and fabricating the mobile phones.

Referring to FIG. 3(c), a helical coil antenna 44 is horizontally located in the housing 34 so that the radiation 46 of the helical coil antenna 44 is emitted outwardly in a direction perpendicular to the diameter of the helical coil antenna 44. FIG. 3(d) is a top view of FIG. 3(c). The electromagnetic wave pattern of the radiation from the helical coil antenna 44 is similar to a donut, i.e. the radiation field strength is larger at the periphery but smaller in the radial direction. Consequently, the influence to the user by the radiation 46 is smaller. The impedance of the helical coil antenna 44 is related to the winding type of the coil and the dielectric coefficient of the filler therein (in oppositely radical proportional to the dielectric coefficient). Therefore, the matching problem of the helical coil antenna 44 can be solved by adjusting the winding type of the coil for the helical coil antenna 44 and the dielectric coefficient of the filler therein so as to obtain suitable impedance and reduce the volume of the antenna. For example, the filler can be made of a resin of high dielectric constant such as silicone resin or a resin containing high dielectric coefficient ceramic powder, such as BaO.xSrO.yTiO2, BaO.xPbO.yLn₂O₃.zTiO₂(Ln: Rare earth), and Bi₂O₃.xZnO.yNb₂O₅ etc. Theoretically, the helical coil antenna using a filler with a dielectric coefficient ε can reduce the dimension to 1/(ε)^{1/2} of the original length. If ε is larger than 10, the antenna dimension can be changed to one third of the original, i.e. a helical coil antenna with the original diameter in 8.1 mm and the length in 18 mm can be shrunk to an antenna with the diameter in 2.7 mm and the length in 6 mm so as to be easily mounted in the handset.

According to the preferred embodiment of the present invention, the monopole antenna 32 can be replaced with other types of antenna such as a helical coil antenna by using the above-mentioned method to adjust the impendence and solve the matching problem.

Besides the manufacture of a mobile phone, the present invention can be applied to refit an existing mobile phone by dismantling the original antenna and mounting the antenna according to the present invention. This is an easy procedure that can be completed by the user of a mobile phone. The radiation of the hidden antenna according to the present invention is reduced by about 0.3 dB from the conventional exposed antenna since a portion of the radiation is shielded by the circuit board and the shielding metal on the handset. The reception strength of handset is higher than the lower limit strength of about 20 dB. Such a difference will not influence the performance of radiation and reception of the hidden antenna.

The above-described embodiments of the present invention are intended to be illustrative only. Numerous alternative embodiments may be devised by those skilled in the art without departing from the scope of the following claims.

What is claimed is:

1. A mobile phone of reducing radiation injury, comprising:
a motherboard;
a shielding metal for preventing the motherboard from electromagnetic interference;
a housing for encapsulating the motherboard and the shielding metal; and
an antenna positioned on a side of the shielding metal opposite to the motherboard, the antenna hidden inside the housing or protruded the housing slightly.

2. The mobile phone of reducing radiation injury of claim 1, wherein the antenna is a monopole antenna.

3. The mobile phone of reducing radiation injury of claim 2, wherein the impedance of the antenna can be adjusted by changing the length or the radius of the antenna.

4. The mobile phone of reducing radiation injury of claim 1, wherein the antenna is a helical coil antenna.

5. The mobile phone of reducing radiation injury of claim 4, wherein the helical coil antenna is positioned horizontally inside the housing.

6. The mobile phone of reducing radiation injury of claim 4, wherein the helical coil antenna comprises filler made of a resin containing ceramic powder with high dielectric coefficient.

7. The mobile phone of reducing radiation injury of claim 4, wherein the helical coil antenna comprises filler made of a high dielectric constant resin.

8. The mobile phone of reducing radiation injury of claim 7, wherein the high dielectric constant resin is silicone.

9. The mobile phone of reducing radiation injury of claim 4, wherein the helical coil antenna comprises a resin containing BaO.xSrO.yTiO₂ powder as a filler.

10. The mobile phone of reducing radiation injury of claim 4, wherein the helical coil antenna comprises a resin containing BaO.xPbO.yLn₂O₃.zTiO₂ powder as a filler.

11. The mobile phone of reducing radiation injury of claim 4, wherein the helical coil antenna comprises a resin containing Bi₂O₃.xZno.yNb₂O₅ powder as a filler.
